(19) United States
(12) Patent Application Publication
(10) Pub. No.: US 2014/0284856 A1
(43) Pub. Date: Sep. 25, 2014

(54) LIGHT WEIGHT COMPOSITE LEAF SPRING AND METHOD OF MAKING

(71) Applicant: Gordon Holdings, Inc., Englewood, CO (US)

(72) Inventor: Kevin E. Stay, Montrose, CO (US)

(73) Assignee: GORDON HOLDINGS, INC., Englewood, CO (US)

(21) Appl. No.: 14/212,958

(22) Filed: Mar. 14, 2014

Related U.S. Application Data
(60) Provisional application No. 61/788,199, filed on Mar. 15, 2013.

(51) Int. Cl. B60G 11/02; B60G 11/10; F16F 1/368

(52) U.S. Cl. CPC B60G 11/02; F16F 1/368; B60G 11/10
USPC 267/47; 267/158; 156/60; 156/313

(57) ABSTRACT

A composite leaf spring comprising a thermoset matrix material reinforced with fibers embedded in the matrix of the composite leaf spring.

### CROSS-REFERENCE TO RELATED APPLICATION

This patent application claims priority benefit under 35 U.S.C. §119(e) of copending, commonly owned U.S. Provisional Patent Application Ser. No. 61/788,199, filed on Mar. 15, 2013, the contents of which is incorporated by reference herein in its entirety.

### TECHNICAL FIELD

The present disclosure is generally directed to leaf springs and particularly directed to composite leaf springs and methods of making the leaf springs for applications, such as automotive systems.

### BACKGROUND

Vehicle manufacturers have long sought to reduce weight of vehicles for the purposes of improving fuel economy, increasing payload capacity, and enhancing the ride and handling characteristics of automobiles, trucks, utility vehicles, and recreational vehicles. Moreover, automotive companies also desire ways to cost effectively reduce vehicle weight in order to meet federally mandated fuel economy requirements.

A large proportion of vehicles employ steel leaf springs as load carrying and energy storage devices in their suspension systems. While an advantage of steel leaf springs is that they can be used as attaching linkages and/or structural members in addition to their capacity as an energy storage device, they are substantially less efficient than other types of springs in terms of energy storage capacity per unit of mass, thereby also reducing fuel economy. Steel leaf springs are heavy by nature, noisy, and subject to corrosion. This weight requires additional consideration with respect to mounting requirements, as well as damping requirements. For instance, shock absorbers are often necessary with the use of steel leaf springs in order to control the mass of the leaf spring under operating conditions.

Accordingly, what is needed is an alternative leaf spring that can provide a lighter weight assembly construction thereby increasing vehicle fuel economy.

### SUMMARY

According to aspects illustrated herein, there is provided a composite leaf spring comprising a thermoset matrix material reinforced with fibers embedded in the matrix of the composite leaf spring.

According to further aspects illustrated herein, there is provided a method of making a composite leaf spring. The method comprises forming a plurality of layers of composite material comprising a fiber reinforced thermoset polymeric material to form a plurality of precut and shaped blanks. The method further comprises inserting and stacking the blanks in a gluing fixture; and gluing the blanks to form the composite leaf spring.

### BRIEF DESCRIPTION OF THE DRAWINGS

FIG. 1 is a schematic illustration of a hybrid composite leaf spring assembly including a flat, second stage load leaf (overload spring), according to embodiments;

FIG. 2 is a cross-sectional view of the primary stage of the composite leaf spring assembly of FIG. 1;

FIG. 3 is a schematic illustration of an alternate configuration of a composite leaf spring assembly comprising a main leaf and a flat composite second stage load leaf (overload spring), according to embodiments;

FIG. 3A is a schematic illustration of a further configuration of a composite leaf spring comprising a main leaf and a composite second stage load leaf (overload spring) of a curved form, according to embodiments;

FIG. 3B is a schematic illustration of another configuration of a composite leaf spring comprising a main leaf and a composite second stage load leaf (overload spring) of a straight form, according to embodiments;

FIG. 4 is a schematic illustration of a perspective view of a composite leaf spring (e.g., second stage load leaf/overload spring), according to embodiments;

FIG. 5 is a schematic illustration of a perspective view of another composite leaf spring (e.g., second stage load leaf/overload spring), according to embodiments;

FIG. 6 is a schematic illustration of a perspective view of a further composite leaf spring (e.g., second stage load leaf/overload spring), according to embodiments;

FIG. 7 is a schematic illustration of a perspective view of another composite leaf spring (e.g., second stage load leaf/overload spring), according to embodiments; and

FIG. 8 is a schematic illustration of a top, perspective view of the composite leaf spring of FIG. 7.

### DETAILED DESCRIPTION

The inventors have determined that the composite leaf springs disclosed herein comprised of fiber reinforced thermoset polymeric (FRTP) materials can provide a much lighter assembly than, e.g., traditional steel leaf springs, and thereby increase fuel economy of a vehicle, such as an automobile, light truck, and so forth. In addition, the fiber reinforced composite leaf springs and assemblies disclosed herein transmit less noise than steel leaf springs, and require less damping force than steel leaf springs to maintain control under operating conditions.

The composite leaf springs disclosed herein, according to embodiments, comprise overload springs, often referred to as second stage load leafs. According to embodiments, a composite leaf spring comprises a thermoset matrix material reinforced with fibers embedded in the matrix of the composite leaf spring. The polymer matrix from which the composite leaf spring and/or composite layers thereof are manufactured comprises any suitable thermoset polymeric matrix material, according to embodiments. Non-limiting examples of suitable thermoset matrix materials include phenolics, polyesters, epoxides, combinations thereof, and so forth.

Particles or fibers that are embedded in the polymer matrix material to form the thermoset composite material can include, but are not limited to, carbon, glass, Kevlar® fiber, aramid fibers, combinations of the foregoing, and the like that are embedded in the polymer matrix material to form the polymer composite material. In addition to the above-described particles and fibers, iron particles can also be incorporated into the composite material disclosed herein. It is noted that the fibers can be continuous and/or non-continuous fibers.

According to embodiments, fiber reinforced thermoset composite leaf springs may generally be comprised of a combination of thermoset polymeric matrix materials, high strength reinforcing fibers and other reinforcing materials.

Thermoset polymer loading by weight can vary widely depending on physical property requirements of the intended use of the product sheet. A composite material may contain about 50 to about 15 wt % thermoset matrix, more preferably about 40 to about 20 wt % and most preferably, about 30 to about 25 wt % of thermoset matrix material, by weight of thermoset matrix material plus fibers.

The reinforcing fibers used may include, but are not limited to, glass fibers (such as E-glass and S-glass), aramid fibers (KEVLAR®), carbon fibers, and other high strength fibers and combinations thereof. Other fibers may also be incorporated, preferably in combination with E-glass and/or S-glass, but optionally instead of E- and/or S-glass. Such other fibers include ECR, A and C glass, as well as other glass fibers; fibers formed from quartz, magnesia alumuninosilicate, non-alkaline aluminoborosilicate, soda borosilicate, soda silicate, soda lime-aluminosilicate, lead silicate, non-alkaline lead boroalumina, non-alkaline barium boroalumina, non-alkaline zinc boroalumina, non-alkaline iron aluminosilicate, cadmium borate, alumina fibers, asbestos, boron, silicone carbide, graphite and carbon such as those derived from the carbonization of polyethylene, polyvinylalcohol, saran, aramid, polyamide, polybenzimidazole, polyoxadiazole, polyphenylene, PPR, petroleum and coal pitches (isotropic), mesophase pitch, cellulose and polyacrylonitrile, ceramic fibers, metal fibers as for example steel, aluminum metal alloys, and the like.

Where high performance is required and cost justified, high strength organic polymer fibers formed from an aramid exemplified by Kevlar may be used. Other preferred high performance, unidirectional fiber bundles generally have a tensile strength greater than 7 grams per denier. These bundled high-performance fibers may be more preferably any one of, or a combination of, aramid, extended chain ultra-high molecular weight polyethylene (UHMWPE), poly [p-phenylene-2,6-benzobisoxazole] (PBO), and poly[diimidazo pyridinylene (dihydroxy) phenylene].

In addition, materials such as metals, e.g., aluminum, steel, and other ferrous and/or non ferrous metals, plastics, epoxies, composites, and/or other suitable materials may be used as reinforcements, additives or inserts to impart specific mechanical, dimensional or other physical properties either uniformly throughout the spring, or in specific regions of the spring.

It is noted that an exemplary, non-limiting combination of materials for a composite leaf spring, according to embodiments, is an epoxy matrix reinforced with E-glass fibers.

Various constructions and configurations of leaf springs and assemblies, according to embodiments, are set forth below. It is noted that advantageously with respect to the following descriptions and embodiments, any or all of the components of the leaf spring and/or assemblies can be made of the afore-described fiber reinforced thermoset polymeric (FRTP) composite materials and optional additional reinforcements, and in any combination of materials thereof. Moreover, it is noted that like reference numerals set forth in the Figures refer to like elements and descriptions, accordingly.

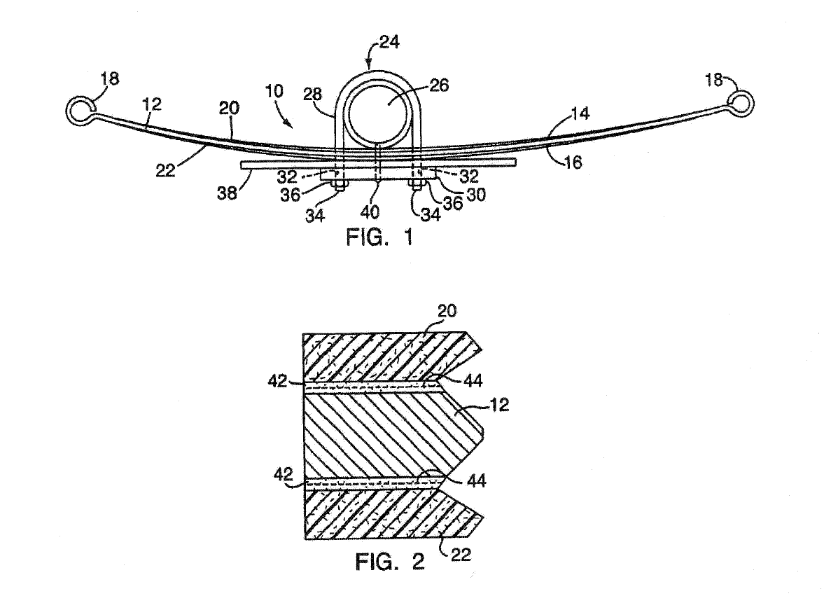

With reference to FIG. 1, a hybrid leaf spring in accordance with a first embodiment of the present invention is generally designated by the reference number 10. The hybrid leaf spring 10 includes an elongated primary leaf 12 having a first modulus of elasticity, a tension surface 14, an opposing compression surface 16, and mounting sections 18, shown as, but not limited to, mounting eyes formed integrally with the ends of the elongated primary leaf 12 for coupling the primary leaf 12 to a vehicle frame. The elongated primary leaf 12 is formed from a suitable material, such as but not limited to metal, e.g., steel. Alternatively, the primary leaf 12 may be fabricated from a metal-matrix-composite material which can include a plurality of fibers imbedded in a metallic matrix. Still further, the primary leaf 12 may be made of the afore-described fiber reinforced thermoset polymeric (FRTP) composite materials and optional additional reinforcements, and in any combination of materials thereof

At least one layer of composite material generally, but not limited to, having an elastic modulus lower than the material of the primary leaf 12, is disposed substantially parallel to and bonded to one of the tension surface 14 and the compression surface 16 of the primary leaf 12, according to embodiments. The at least one layer of composite material is preferably formed from a plurality of substantially parallel fibers embedded in a polymeric matrix. As shown in FIG. 1, a first layer of composite material 20 is bonded to the tension surface 14 of the primary leaf 12, and a second layer of composite material 22 is bonded to the compression surface 16 of the primary leaf 12.

The hybrid leaf spring 10 is typically fabricated by bonding the first layer of composite material 20 and the second layer of composite material 22 to the primary leaf 12 and placing the assembled components in a press employing a heated die having a shape conforming to the desired unloaded shape of the finished hybrid leaf spring. The components are then pressed together and through the combination of heat and pressure hybrid leaf springs of consistent repeatable shape can be formed. However, the present invention is not limited in this regard as other fabrication techniques known to those skilled in the pertinent art, such as molding, may be employed.

A clamping means 24 is employed to couple the leaf spring 10 in a three-point configuration to an axle 26 of a vehicle, according to embodiments. In the illustrated embodiment, the clamping means 24 includes a pair of U-bolts 28 extending around the axle 26 with the leaf spring 10 being received between the U-bolts. A locking plate 30 defining two pairs of apertures 32 for receiving ends 34 of the U-bolts 28 is positioned adjacent to the second layer of composite material 22 and fasteners 36 are threadably engaged with the ends of the U-bolts for releasably clamping the U-bolts and the leaf spring 10 onto the axle 26. In addition, a load leaf 38 for enhancing the load carrying capacity of the leaf spring 10 in the area of highest stress is interposed between the second layer of composite material 22 and the locking plate 30.

A load leaf (overload spring) 38 can be bonded to the second layer of composite material 22 or it can be retained in contact with the second layer of composite material by the clamping means 24. The load leaf (overload spring) 38 can be either curved or flat, and may or may not vary in cross-section and be constructed of, e.g., the afore-described fiber reinforced thermoset polymeric (FRTP) material.

In order to properly position the leaf spring 10 along the axle 26, a positioner 40 is engaged with the axle 26, according to embodiments, and in the illustrated embodiment of FIG. 1 extends through the leaf spring 10, the load leaf (overload spring) 38, and the locking plate 30 and into the axle 26 thereby fixing the position of the leaf spring 10 relative to the axle 26. The positioner 40 may take various forms, and in the illustrated embodiment is a pin; however, a bolt and so forth can also be used without departing from the scope of the present invention.

Advantageously, the inventors have herein determined that one or all of the components of the leaf spring 10 of FIG. 1 can be made of the afore-described fiber reinforced thermoset polymeric (FRTP) material.

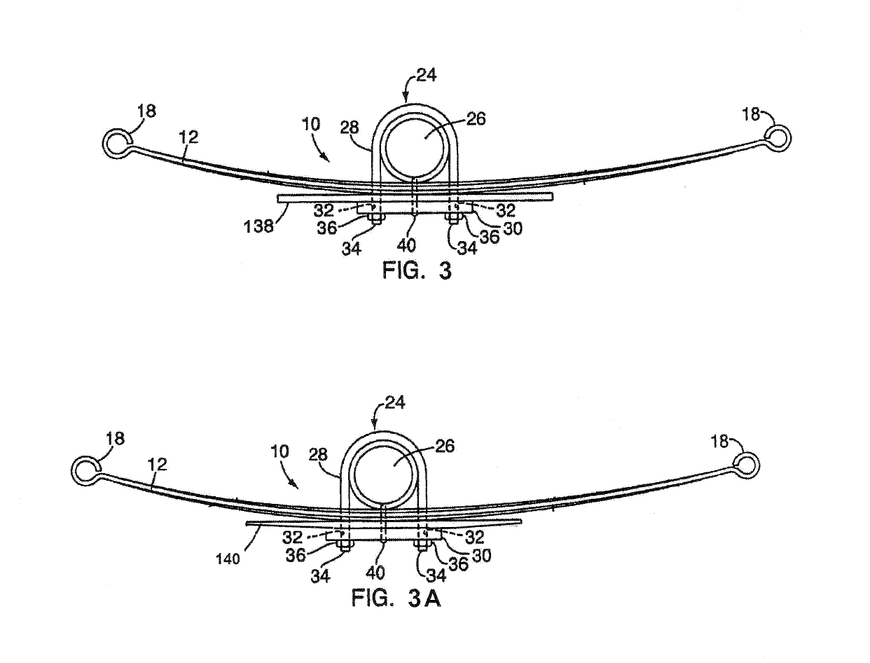

As shown in FIG. 2, to increase bond strength, adhesive layers 42 are interposed between the primary leaf 12 and each of the first and second composite layers 20, 22 each including a reinforcing layer of sheet material 44, schematically indicated by dashed lines, disposed within the adhesive layer 42, according to embodiments. Each adhesive layer 42 is preferably a thermoset epoxy adhesive, but may be other types of adhesive without departing from the scope of the present invention. For example, the adhesive may be traditional one or two part liquid structural adhesives such as epoxies, or may be urethanes and thermoplastics.

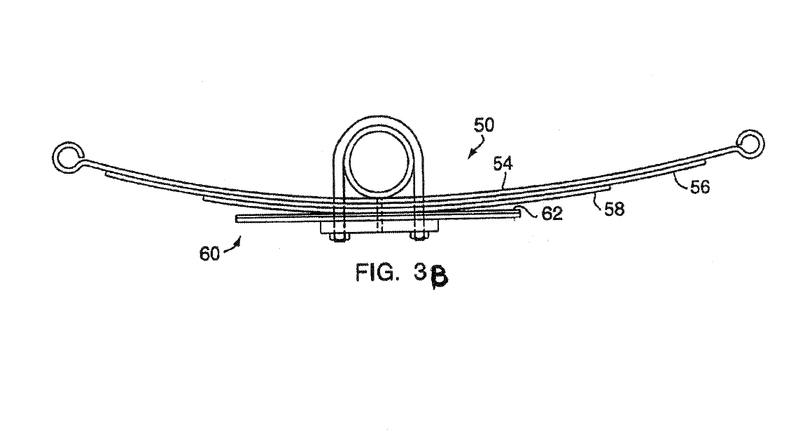

Another embodiment is shown in FIG. 3 in which previously described elements bear the same reference numerals. In this embodiment, the primary leaf is, e.g., a conventional steel primary leaf without composite layers and the second stage load leaf (overload spring) 138 is a flat fiber reinforced thermoset polymeric (FRTP) composite structure, according to embodiments, and provides for enhancing the load carrying capacity of the leaf spring 10 in the area of highest stress.

FIG. 3A shows a similar leaf spring assembly where the second stage leaf (overload spring) 140 is a curved FRTP composite structure of the invention, providing enhanced secondary support of the primary leaf spring.

FIG. 3B shows a further embodiment of a leaf spring assembly, wherein the main spring comprise a plurality of primary leaf elements, 54, 56 and 58, respectively. A second stage leaf (overload spring) 60 comprising the afore-described FRTP material is also depicted in the assembly 50 of FIG. 3B. As in the case of the afore-described embodiments, any or all of the components of the leaf spring assembly of FIG. 3B can comprise the FRTP composite material disclosed herein, and in any combinations. Moreover, according to embodiments, the second stage leafs disclosed herein can comprise a layer or coating thereon. For example, FIG. 3B depicts second stage leaf (overload spring) 60 comprising a coating 62 thereon. The coating can comprise any suitable layer/material such as composite, metal, combinations thereof and so forth. Typically, coating 62 will have a thickness less than the thickness of the second stage leaf (overload spring), e.g., as depicted in FIG. 3B at reference numeral 60.

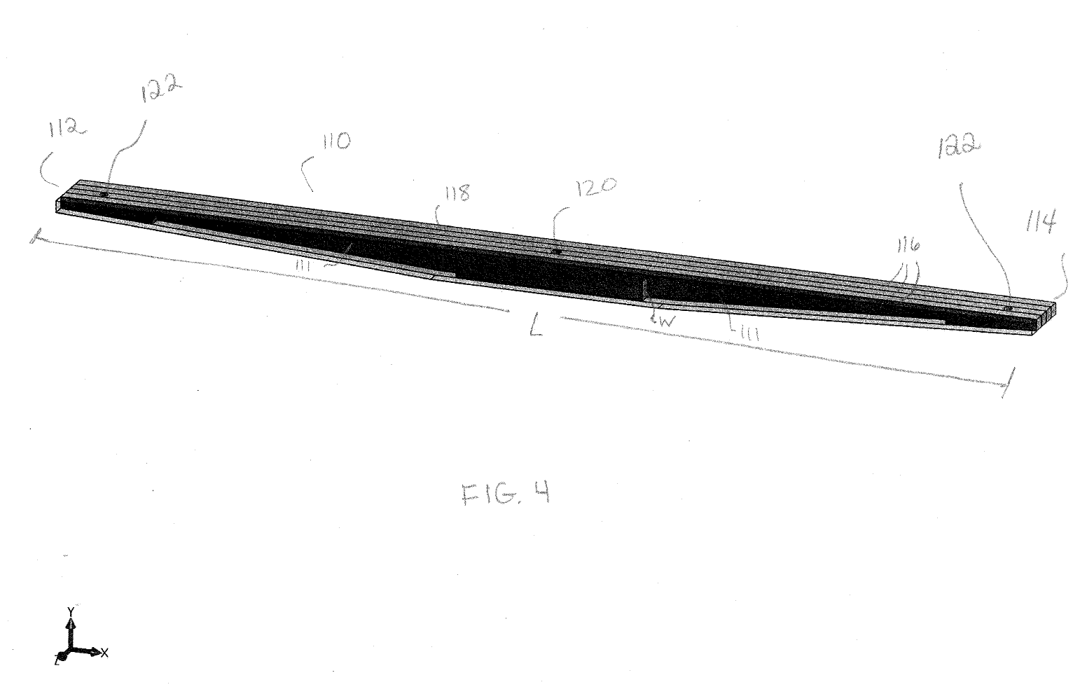

FIG. 4 shows an embodiment of the invention comprising a leaf spring 110 made of the afore-described fiber reinforced polymeric (FRPT) thermoset composite material of the invention. In the depicted embodiment, leaf spring 110 is a second stage load leaf (overload spring). The overload spring thus comprises a thermoset matrix material reinforced with fibers embedded in the matrix of the composite leaf spring. However, by way of illustration only, leaf spring 110 could be usable in replacement of a primary leaf spring 12 in the configuration as shown in FIG. 1, thus potentially providing weight savings and customizable spring characteristics by modification of the types of reinforcement and layer configuration chosen for a given application. It could also serve as a single stage leaf spring alone where no second stage supplemental support is necessary in the application. Such applications may include light trailer application and so forth.

Accordingly, composite leaf springs in accordance with embodiments herein, may utilize a single leaf design, as shown in, e.g., FIG. 4, or a multiple stage leaf designs such as, the leaf springs/assemblies, as shown in, e.g., FIGS. 1, 3, 3A and 3B.

Typically, however, the leaf spring 110 functions as a second stage leaf (overload spring 110), e.g., within, on or under, a stack of other leafs, and comprising the afore-described fiber reinforced thermoset polymeric (FRTP) composite material.

The overload spring 110 of FIG. 4 is depicted therein as comprising a length, L, extending between a first end 112 and a second end 114 of the overload spring 110. In the depicted embodiment, a plurality of stacked layers 116 are aligned next to each other extending from the first end 112 to the second end 114, and are vertically aligned along the length, L, of the overload spring 110, as shown in FIG. 4. The plurality of stacked layers 116 typically comprise the afore-described fiber reinforced thermoset polymeric (FRTP) composite material. As further shown in FIG. 4, the plurality of stacked layers 116 can form ridges 118 where the stacked layers are aligned and joined. It is noted that methods of manufacturing overload spring 110 including the joining of the stacked layers 116, such as by the use of a suitable adhesive, is described in further detail below.

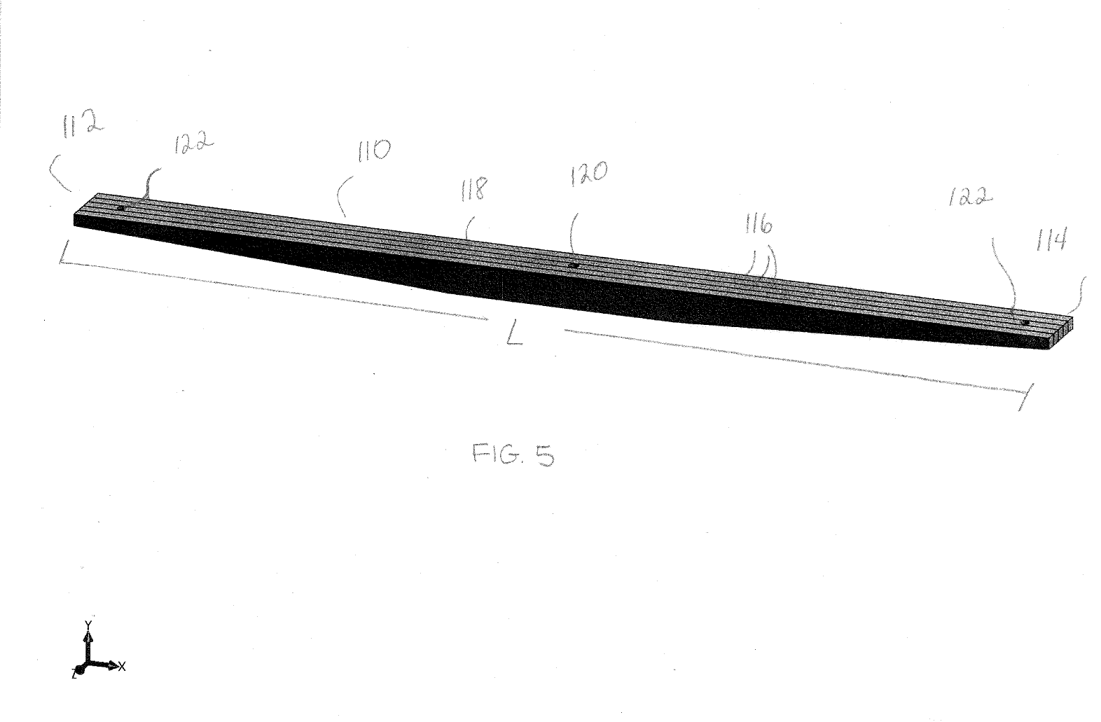

A cut away section 111 is also shown in FIG. 4 to illustrate the width, W, of one of the stacked layers 116. Accordingly, the width, W, or each layer 116 can be substantially the same, as shown in FIG. 4, or the layers 116 can comprise differing widths. Typically, the widths, W, will be substantially the same, according to embodiments, for ease of manufacturing. A non-limiting example of a suitable width, W, for the layers 116 is between about 0.25 inches to about 1 inches, including about 0.5 inches. However, the invention is not so limited to these particular values. It is noted that FIG. 5 depicts the overload spring 110 without showing the afore-referenced cut away section.

A positioner 120 is also depicted in FIG. 4 in the plurality of stacked layers 116. The positioner 120 extends through the spring 110 and is configured to attach to an axle of a vehicle, such as an automobile, light truck, and so forth, according to embodiments. The positioner 120 may take various forms, such as a pin, bolt, and so forth.

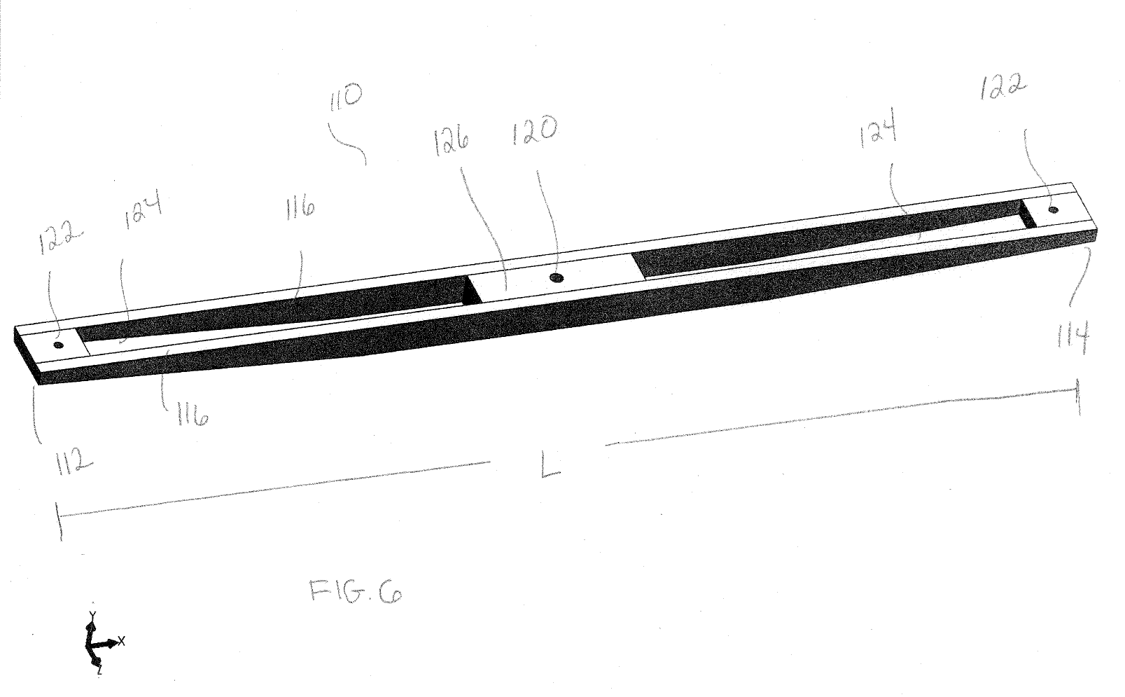

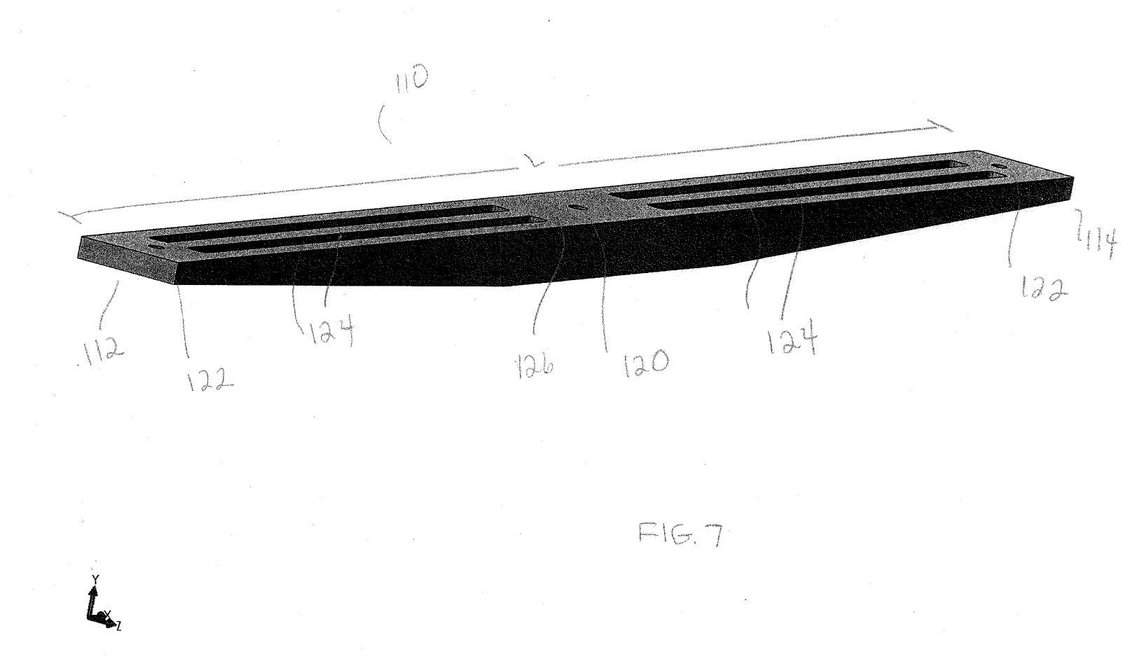

Also depicted in FIG. 4 are attachments sections 122 located at the first end 112 and second end 114 of the overload spring 110. The attachment sections 122 also may take various forms, such as a pin, and so forth. In the embodiments shown in FIGS. 6 and 7, the attachment sections 122 are each depicted as an insert/spacer at each end of the overload spring 110. However, various configurations may be employed including, but not limited to, attachment eyes, clamping mechanisms, linkages, combinations thereof, and so forth.

It is further noted that the embodiment of FIG. 4 is depicted in a curved, tapered fashion. However, the overload spring 110 can comprise other suitable shapes, such as flat, and so forth.

The inventors have also determined that in addition to employing the afore-referenced fiber reinforced thermoset polymeric (FRTP) composite material, the weight of the resultant structures and assemblies can be even further reduced by varying, e.g., increasing the section modulus of the composite leaf spring (e.g., overload spring) 110 thus eliminating width.

Accordingly, as shown in, e.g., the embodiments of FIGS. 6 and 7, the overload spring 110 can comprise at least one open channel 124 of desired shape and size. Use of such an open channel 124 reduces the amount of material employed in construction, thereby reducing overall weight and increasing fuel economy efficiency of the vehicles in which the spring 110 are employed. FIG. 6 depicts two rectangular shaped channels 124. However, more or less channels could be employed, and in other desired shapes, such as square, and so forth. Thus, the size and shape of the channels 124 can vary, as needed, and based upon, e.g., product specifications and requirements.

FIG. 6 further depicts an insert 126 or spacer 126 positioned between two stacked layers 116 and assisting in defining the channels 124. For example, if a certain width of the overload spring 110 is desired, multiple load bearing elements can be spaced, accordingly, as shown in, e.g., FIGS. 6-8. It is noted that the inserts/spacers 126 can be made of any suitable materials including composites, such as the afore-described fiber reinforced thermoset polymeric (FRTP) composite materials, aluminum, steel, combinations thereof, and so forth. The inserts/spacers 126 are typically solid, although not limited thereto, in construction and can be made out of, e.g., a solid bar of desired composition, to the desired shape and size.

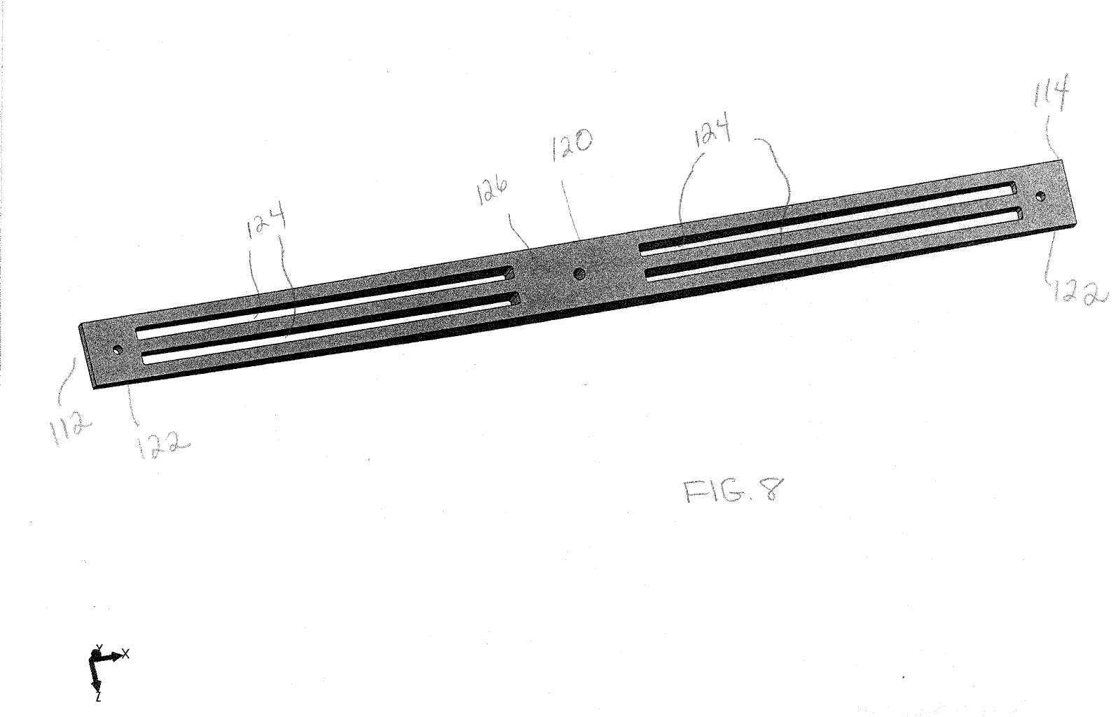

In the embodiment depicted in FIG. 7, four open channels 124 are shown. However, as noted above, more or less open channels 124 could be employed depending upon, e.g., product specifications and requirements. Also, FIG. 7 depicts a resultant overload spring 110 after, e.g., consolidating, the manufacturing process of which is further described below, and FIG. 8 illustrates a top view of FIG. 7.

It is further noted that while individual stacked layers 116 are described above in various embodiments of the composite leaf spring 110 (e.g., overload spring 110), embodiments could be machined/molded, e.g., without such layering and in the resultant configurations disclosed herein, such as in a one piece configuration with, e.g., open channels 124 and with inserts 126 integrally formed therein.

With regard to the methods of manufacturing, it is noted that the composite leaf springs, assemblies and so forth, according to embodiments, can be manufactured by combining the afore-described fiber reinforced thermoset polymeric (FRTP) material including the reinforcing fibers and other appropriate materials in the presence of heat and/or pressure, usually in a mold or other device that imparts a desired shape to the assembly. The heating and consolidating can typically be performed at, e.g., between about 400° F. and about 600° F., including between about 450° F. and about 550° F., and at a pressure of, e.g., up to about 300 psi for construction.

Also, according to embodiments, bar stock of desired material, e.g., comprising the afore-referenced fiber reinforced thermoset polymeric (FRTP) composite material of desired thickness, such as. e.g., about 0.5 inches, can be slit to a desired width. The material is then cut to the appropriate length, including end tapers if desired. The precut and shaped bar stock blanks are placed in a gluing (adhesive) fixture employing a suitable glue/adhesive, along with appropriate glued or pinned spacers. Accordingly, possible design/manufacturing modifications include stacking and gluing/pining the, e.g, 0.5 inch shaped composite bar stock to the desired width; utilization of spacers including, e.g, composite, metal, plastic, and so forth, stacked and glued/pinned to the load shaped bearing composite bar stock lineals to achieve the desired with; and stacking and gluing/pinning of the, e.g., 0.5 inch bar stock to the desired width and then machining out the channels or slots. It is further noted at a bar stock of about 0.5 inches is advantageously able to achieve a faster cure time than, e.g, much thicker stocks. However, the invention is not limited to this particular thickness and any suitable dimensions/configurations may be employed. A further advantage of embodiments disclosed herein is that hybrid constructions are disclosed herein where, e.g, composites can be employed in the load bearing structure and the same, or even alternative materials can be employed in mounting sections where, e.g, abrasion or compressive properties are needed and can be addressed with use of suitable materials having the desired properties therefore.

The final strength and stiffness, as well as other desirable properties, depends upon the thermoset material(s) used, as well as the type, size, and orientation of the reinforcements and other materials used. In addition, the strength and stillness of the final product is also dependent upon the overall dimensional shape of the composite leaf spring, including length, width, thickness, and cross-sectional areas.

In some embodiments, the shape of the composite leaf spring may be developed by buildup of layers of pre-impregnated (prepreg) reinforcing materials. This buildup of layers is usually inserted into a shaped tool or mold, where heat and/or pressure may be applied to consolidate the materials.

Although this invention has been shown and described with respect to the detailed embodiments thereof, it will be understood by those skilled in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

What is claimed is:

1. A composite leaf spring comprising a thermoset matrix mat reinforced with fibers embedded in the matrix of the composite leaf spring.

2. The composite leaf spring of claim 1, wherein the composite leaf spring is an overload spring.

3. An assembly comprising the overload spring of claim 2, wherein the assembly is configured to attach to an automotive vehicle frame.

4. The composite leaf spring of claim 2, wherein the overload spring comprises a length extending between a first end of the overload spring and a second end of the overload spring, and wherein a plurality of stacked layers comprising the thermoset matrix material reinforced with fibers embedded in the matrix are aligned next to each other extending from the first end to the second end, and being vertically aligned along the length of the overload spring.

5. The composite leaf spring of claim 4, wherein the stacked layers form a plurality of ridges.

6. The composite leaf spring of claim 5, further comprising a positioner configured to attach to an axle of a vehicle.

7. The composite leaf spring of claim 4, comprising an insert between the plurality of layers.

8. The composite leaf spring of claim 7, wherein the insert comprises a positioner configured to attach to an axle of a vehicle.

9. The composite leaf spring of claim 7, wherein the insert is made of a material selected from the group consisting of: a thermoset material, a thermoplastic material, a metal, a composite, a fiber reinforced thermoset matrix composite, and combinations thereof.

10. The composite leaf spring of claim 8, wherein at least one open channel is located between the plurality of layers and adjacent the insert.

11. The composite leaf spring of claim 4, wherein thermoset matrix material is selected from the group consisting of phenolics, polyesters, epoxides, and a combination thereof

12. A method of making a composite leaf spring comprising;
forming a plurality of layers of composite material comprising a fiber reinforced thermoset polymeric material to form a plurality of precut and shaped blanks;
inserting and stacking the blanks in a gluing fixture; and
gluing the blanks to form the composite leaf spring.

13. The method of claim 12, wherein the composite leaf spring is an overload spring.

14. The method of claim 13, further comprising positioning at least one insert between the layers.

15. The method of claim 14, further comprising forming at least one channel between the layers.
